(19) United States
(12) Patent Application Publication
(10) Pub. No.: US 2022/0250364 A1
(43) Pub. Date: Aug. 11, 2022

(54) CELEBRATORY BALLOON WITH METALIZATION AND GAS ADMIXTURES

(71) Applicant: Anagram International, Inc., Eden Praire, MN (US)

(72) Inventors: Dean Scott Borchardt, River Falls, WI (US); Henry H. Hickman, Woodridge, IL (US)

(21) Appl. No.: 17/670,201

(22) Filed: Feb. 11, 2022

Related U.S. Application Data
(60) Provisional application No. 63/148,327, filed on Feb. 11, 2021.

(51) Int. Cl. B32B 27/08; B32B 1/00; B32B 27/34; B32B 27/30; B32B 27/32; B32B 27/36; A63H 27/10

(52) U.S. Cl. CPC B32B 27/08; A63H 2027/1025; B32B 27/34; B32B 27/306; B32B 27/32; B32B 27/36; A63H 27/10; B32B 2307/75; B32B 2255/10; B32B 2307/7242; B32B 2307/31; B32B 2255/205; B32B 2307/402; B32B 2255/20; B32B 2451/00; B32B 1/00

(57) ABSTRACT

A celebratory balloon fabricated from polymeric films have a deposited insularly array of metal which may be further enhanced by polymer encapsulation of the metal. When the balloon is inflated with an admixture of helium and an electronegative gas, the balloon demonstrates to have high breakdown strength across the balloon surface and within the balloon through the inflation gas. The gas mixture further enhances the breakdown strength of the inflation gas by increasing the onset voltage of corona, streamers and spark breakdown. The admixture gas also enhances the breakdown strength of metal-free galloons such as non-metalized balloons, clear balloons, and latex balloons.

### BACKGROUND OF THE INVENTION

For as long as the non-latex celebratory foil balloon has been around, there has been concern by utility commissions, power municipalities, and regulatory bodies on the incidental or purposeful release of these lighter-than-air balloons coming in contact or becoming entangled within the energized components of the overhead electrical grid system. Current powerline fault protection devices designed for grid protection have difficulty detecting infringing foreign objects such as balloons, animals, birds, tennis shoes, kites, tree branches, or even detecting electrical wires touching the ground. Over the years, the balloon industry has seen governmental regulations enacted regarding such balloon releases, such as requiring warning labels, use of non-metallic tethers and the attachment of weights to counteract the effects of buoyancy, in attempts to reduce powerline/balloon incidences. However, with the increased balloon popularity, the utility commissions and municipalities are experiencing increased powerline/balloon incidences despite the current balloon regulations.

The increased celebratory balloon popularity is partially due to the multitude of purposes such balloons can provide, e.g., cake decorations, floral enhancements, static displays, props, home decor, wedding decorations, conveying sentiments, advertising, promotions, toys, and the like. Depending on the balloon's function, the balloon can be designed to achieve certain floating performance ranging from a non-floating earthbound balloon to a balloon floating at specific elevations with attached adornments.

This invention is concerned with any balloon capable of contacting an electrical source, specifically, a balloon capable of achieving enough lift to loft the balloon into the overhead utility electrical grid. For the purpose of this invention, the balloon can be described as follows: Any envelope, bag, or package potentially capable of retaining a gas within its perimeter and constructed of materials light enough to achieve buoyancy if retaining a lighter-than-air gas; can either exist as a single entity or multiple entities such as a cluster or bunch; can be tethered, tethered with insufficient hold-down weight to counteract buoyancy/lifting force, or untethered; can be fully inflated with gas under pressure, partially inflated with gas, or deflated devoid of gas; can be wind carried into, rise by natural ascension, or placed into the energized electrical field by other means such as being tossed or dropped. Electrical incidents or powerline incidents can occur by the balloon having either direct contact with electrical conductors and/or grounding equipment, by near contact within the induced electrical fields, or by a combination thereof. This invention is not limited to outdoor electrical sources and can be highly beneficial in protecting electrical sources within indoor or enclosed structures such as households, garages, stores, offices, hotels, conference rooms, warehouses, factories, stadiums, and other such indoor facilities.

Most electrical powerline-balloon incidences occur with balloons classified as non-latex foil balloons. The term “foil” is a misnomer for the metalizied polymetric films used for the balloon membrane. FIG. 1 illustrates an example of a typical metalized polymetric balloon membrane film structure 100. Metalized films are either a mono or multi-layered polymer films comprising a base core 102 and a heat sealable layer 103 coated with a thin continuous layer of a metal layer across the films outer surface 101 typically coated by means of a vapor deposition process. The continuous metal layer 101 serves to visually enhance the balloon's graphical appearance particularly when printed with ornamental decoration and to retard the permeation of the retained lighter-than-air inflation gas through the balloon's film membrane 100. Unfortunately, the continuous metal layer 101 significantly reduces the balloon's surface impedance creating an easy electrical pathway for a phase-to-phase or phase-to-ground flashover as the balloon encroaches into the electrical field of the electrical source.

Prior art (Sarnstrom U.S. Pat. No. 7,972,193), FIG. 2 attempts to address the low electrical impedance of the continuous outer metal layer by moving the continuous metal layer 201 deeper within the polymer layers 202, 203 of the balloon film membrane 200. While there is an improvement of the electrical impedance across the outer surface of the balloon film membrane 200, as evidenced by lower surface conductivity, the overall electrical impedance of the balloon remains low due to the presence of the continuous metal layer 201 and shifts the impedance pathway within the balloon film membrane 200 instead of the outer film surface. The thickness of the thin polymeric layers 202 over the metal layer cannot provide enough dielectric strength to withstand the high voltage field of the electrical source thereby allowing the low impedance path to continue to follow the metal layer 201 within the balloon film membrane 200 resulting in similar phase-to-phase or phase-to-ground faults as the typical foil balloon.

Other prior art (Horii U.S. Pat. No. 4,928,908) modifies the process of depositing the metal on the balloon film by controlling the growth of the metal deposits at the nucleation sites during the vapor deposition process resulting in a discontinuous metalization layer resembling “islands in the sea”. Mount (US 2015/0118460) discusses other methods of achieving a discontinuous metal layer by controlling the shape of the deposited metal by way of in-chamber oil masking and vapor deposition first revealed by Yializis (U.S. Pat. No. 6,106,627). Other inventors have found methods of creating a discontinuous metal layer, such as caustic metal etching (Beckett U.S. Pat. No. 4,398,994, Beckett U.S. Pat. No. 4,610,755, Arai U.S. Pat. No. 4,242,378), solvent soluble masking prior to vapor deposition (Brehm US 2006/0073277), metal oxide conversion via hydrophobic ink masking (Bruyns US 2006/0183342), or by photo-sintering of metallic inks (Schroder U.S. Pat. No. 7,820,097, Li U.S. Pat. No. 9,730,333). Both Horii and Mount reveal the discontinuous metal layer can be constructed in a manner to significantly improve the surface dielectric strength of the balloon film membrane while maintaining the desired metallic look of the balloon. While the discontinuous metallization significantly enhances the electrical characteristics of the balloon membrane in comparison to a continuous metal layer balloon membrane, both Horii and Mount fail to consider when an electrical breakdown can occur through an impedance path other than the balloon membrane. An electrical breakdown can occur through the gas retained within the balloon when the dielectric strength of the retained gas is significantly lower than the surrounding gas of the electrical system. Mount also suggests the use of higher dielectric strength polymer films for the balloon membrane. Higher dielectric polymers may allow for some added design flexibility in the configuration of the discontinuous metal geometry for flash over protection. However, the polymer film layers of the balloon membrane are extremely thin for buoyancy/lifting purposes and the higher dielectric strength polymers do not significantly contribute to the increasing the dielectric strength through the balloon film membrane; hence the impedance path through the balloon film membrane into the retained gas remains relatively unaltered for arc-over protection.

When a balloon encroaches an electrical system, it potentially compromises the designed safety margin of the electrical system by locally reducing the electrical system's inherit dielectric strength at the point of encroachment. For an energized system, electrical current will flow through all possible routes and paths regardless of the path's impedance. However, the amount of current flowing through any given path will depend upon the voltage present and the path's impedance. A very high impedance path will have very ow current flow while a very low impedance path will have most of the current flow. For the typical “foil” balloon, the low impedance path becomes the continuous metal layer, causing a large flow of current across the metal layer and developing a disruptive discharge event of a flashover across the balloon surface. Referring to FIG. 3, if the continuous metal layer is removed from the balloon film structure 300 as in the case of a clear balloon, the low impedance pathway may not be across the balloon surface but could be through the retained gas within the balloon potentially causing a disruptive discharge event of an arc-over within the retained gas. Hence, all potential conduction pathways on, around, within, and through the balloon must be considered. Such pathways could be across the balloon surface, through the layers of the balloon film membrane, through an individual film layer of the balloon membrane, across a film layer within the balloon membrane, through the retained gas, or a combination thereof.

Choice of the retained gas within the balloon can greatly affect the balloon's electrical breakdown strength. If the balloon's functionality requires a lifting force to be generated from buoyancy, such as floating the balloon in air or for orienting a balloon to create a certain look, then the choices in pure lifting or lighter-than-air gases are limited. A vast majority of the lighter-than-air gases are inherently dangerous to humans when used as a balloon inflation gas. Gases such hydrogen, borane, methane, ammonia, hydrogen fluoride, methyllithium, acetylene, diborane, hydrogen cyanide, carbon monoxide, and ethylene, all of which have hazards of being combustible, explosive, caustic, poisonous, and/or corrosive. Other lighter-than-air gases such as neon, aerogels (technically not a gas but a structure that could contain a lighter-than-air gas), vacuum, plasma, and water vapor are all technologically and/or economically challenging to implement even though they have been utilized conceptually in the past. Other gases such as nitrogen, are essentially ineffective in providing any reasonable lifting capacity due to its similar molecular weight to air.

Other than the risk of asphyxiation during inhalation, helium is one of safest lighter-than-air gases being non-reactionary, non-hazardous, non-flammable, non-toxic, natural occurring, and economically feasible. Helium has the second greatest lifting capacity, second only to hydrogen, of all the lighter-than-air gases providing the greatest flexibility in balloon design making it the main choice for the celebratory balloon industry. However, helium's major drawback is its relatively low dielectric strength of approximately 15% that of air. When a helium-filled balloon approaches high-voltage lines, the associate electrical fields can create partially conductive pathways (i.e., discharges) within the helium. These discharges exist as corona, streamers and/or leaders depending on the voltage levels encountered. At sufficient voltage stress, the discharges can grow and fully bridge the gap between the conductors, creating a disruptive spark and low-impedance arc discharge. Even helium-filled latex balloons will develop conductive streamers within the helium of the balloon when encroaching the electric field of sufficient voltage. Therefore, any helium-filled celebratory balloon is a risk of causing a powerline incident depending on the balloon type, voltage level, and powerline configuration.

Because of helium's high lifting capacity, the buoyancy requirements of some balloon designs may allow for the addition of other gases to create a helium gas mixture. Prior art describes such mixtures for specific purposes such as limiting buoyancy, controlling gas costs, conserving helium, or to avoid unintentional asphyxiation; however, none of the prior art addresses the usage of helium mixtures to improve the dielectric strength of the retained balloon gas for the protection of the electrical grid. Admix gases heavier than helium cause reduced lifting capability of the balloon, which the balloon industry generally avoids, due to customer loss based on geographical locations. Such balloons require lighter weight balloon film membranes or larger balloon volumes, or a combination of the two, to offset the lost lifting capability in order to maintain the customer base.

Other industries such as the space industry and electrical/power industries have researched and utilized gas mixtures for improving the dielectric performance of their equipment. The space industry has conducted research on various gases for space capsule atmospheres (Dunbar, Technical Report AFAPL-TR-65-122). Dunbar demonstrates the corona onset voltages effects of utilizing admixtures of a dielectric gas with various other gases. Other prior art (Cobine U.S. Pat. No. 2,867,679) utilized mixtures of helium and electronegative gases for creating an efficient heat transferring gas with improved electrical break-down. The electrical power industry consistently uses dielectric gases and gas mixtures to help prevent or rapidly quench electric discharges within equipment such as transformers, circuit breakers, switchgear, etc. While the power industry does not use helium per se in these applications, the typical dielectric gases used includes compressed air, nitrogen, sulfur hexafluoride, carbon dioxide, freons, and fluorocarbons.

### SUMMARY OF THE INVENTION

A celebratory balloon fabricated from polymeric films have a deposited insularly array of metal which may be further enhanced by polymer encapsulation of the metal. When the balloon is inflated with an admixture of helium and an electronegative gas, the balloon demonstrates to have high breakdown strength across the balloon surface and within the balloon through the inflation gas. The gas mixture further enhances the breakdown strength of the inflation gas by increasing the onset voltage of corona, streamers and spark breakdown. The admixture gas also enhances the breakdown strength of metal-free galloons such as non-metalized balloons, clear balloons, and latex balloons. A principal object and advantage of the present invention is that these balloons will not interact with utility distribution systems for any typical combination of conductor spacing and distribution voltages. Unlike existing metallized film balloons, they do not compromise the safety margins of power distribution systems, nor will they trigger a phase-to-phase or phase-to-ground faults.

Another object and advantage of the present invention is that the onset of corona, streamers, and spark breakdowns are all considerably higher than the maximum electrical stress that exists within power distribution networks typically found in the United States and other countries.

Another object and advantage of the present invention is that these balloons significantly reduce the electrical interaction with utility distribution systems for typical powerline conductor spacing/voltage combinations to avoid triggering phase-to-phase or phase-to-ground faults.

Other objects and advantages of the present invention will become apparent upon reading the following detailed description, upon reference to the drawing and a review of the claims.

### BRIEF DESCRIPTION OF THE FIGURES

FIG. 1 is a prior art general cross sectional view of a balloon membrane for a typical metalized balloon;

FIG. 2 is a prior art general cross sectional view of a balloon membrane for a typical metalized balloon with the metal layer buried or encapsulated within the film structure;

FIG. 3 is a prior art general cross sectional view of a balloon membrane for a non-metalized balloon;

FIG. 4 is a general cross sectional view of a balloon membrane for a discontinuous metalized balloon with the metal layer on top of the film structure;

FIG. 5 is a general cross sectional view of a balloon membrane for a discontinuous metalized balloon with the discontinuous metal layer encapsulated within the film structure;

FIG. 6 is a graphic showing of the U.S. Standards and California Standards comparisons for overhead powerlines smallest conductor-to-conductor clearance in inches for a given line voltage;

FIG. 7 is a graphic showing a division of the graph of FIG. 1 into two regions—Region I not allowed within the U.S. (for nonconductive safe balloons); and Region II represents potentially compliant U.S. overhead powerline designs (for conductive unsafe balloons;

FIG. 8 is a graphic showing the breakdown voltage for Examples 1-6 of inflated balloons filled with high purity helium gas spanning a simulated overhead powerline;

FIG. 8a is an enlarged graphic of FIG. 8;

FIG. 9 is a graphic showing of the breakdown voltage for Examples 7-12 inflated balloons filled with an admix gas of 95% helium and 5% oxygen spanning a simulated overhead powerline; and

FIG. 10 is a graph showing the admixture effects on the breakdown strength for balloons of the various embodiments.

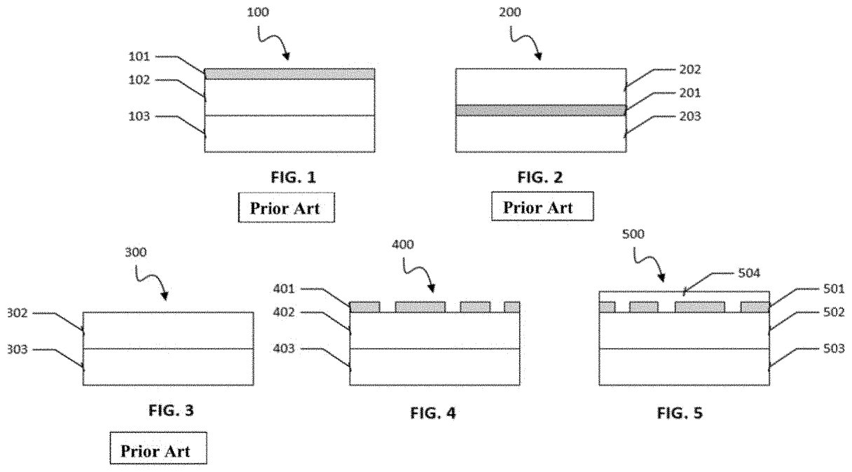

### DETAILED SPECIFICATION

This invention describes an admixture of a lighter-than-air gas and a dielectric gas, preferably, helium and a dielectric gas, more preferably, helium and an electronegative gas, to increase the overall dielectric strength of the inflation gas retained within the balloon. The lighter-than-air gas may be comprised of one or more lighter-than-air gases. The dielectric gas may be comprised of one or more dielectric gases. Dielectric gases could be but are not limited to: hydrogen, ammonia, carbon monoxide, nitrogen, air, oxygen, chlorine, hydrogen sulfide, carbon dioxide, nitrous oxide, sulfur dioxide, trifluoromethane, tetrafluoromethane (R-14), tetrafluoroethane (R-134a), dichlorodifluoromethane (R-12), hexafluoroethane (R-116), sulfur hexafluoride (146), hexafluoropropane (R-236fa), dichlorotetrafluoroethane (R-114), perfluoropropane (R-218), octafluorocyclobutane (R-C318), and perfluorobutane (R-3-1-10). Some dielectric gases may have negative environmental impacts such as being a greenhouse gas if released or by forming reactive/hazardous chemical species when the admixture is exposed to high voltage. With the introduction of another gas into the lighter-than-air gas, the molecular weight of the dielectric gas becomes important to the buoyancy/lifting capability of the inflated balloon. Dielectric gas molecules heavier than the lighter-than-air gas will have a negative impact on the balloon's lifting capability, i.e. the heavier the dielectric gas molecular weight, the less amount of dielectric gas that can be added to maintain balloon buoyancy. Besides the environmental concerns, the potentially harmful chemical generation, and the potential lifting capability loss, the choice in dielectric gas is also predicated on the dielectric efficiency defined as the rate of dielectric strength improvement given the admixture composition. If the dielectric gas is heavier than the lighter-than-air gas, it is preferable to add the smallest amount of dielectric gas to the lighter-than-air gas to limit the loss of lifting capacity while maintaining the balloon size and still substantially increasing the dielectric strength of the admixture gas without causing additional harm to people and the environment.

FIG. 4 shows the discontinuous or insular array of a metal layer 401 on top of a balloon membrane film structure 400 and polymer core 401 and a heat sealable layer 403 therebelow.

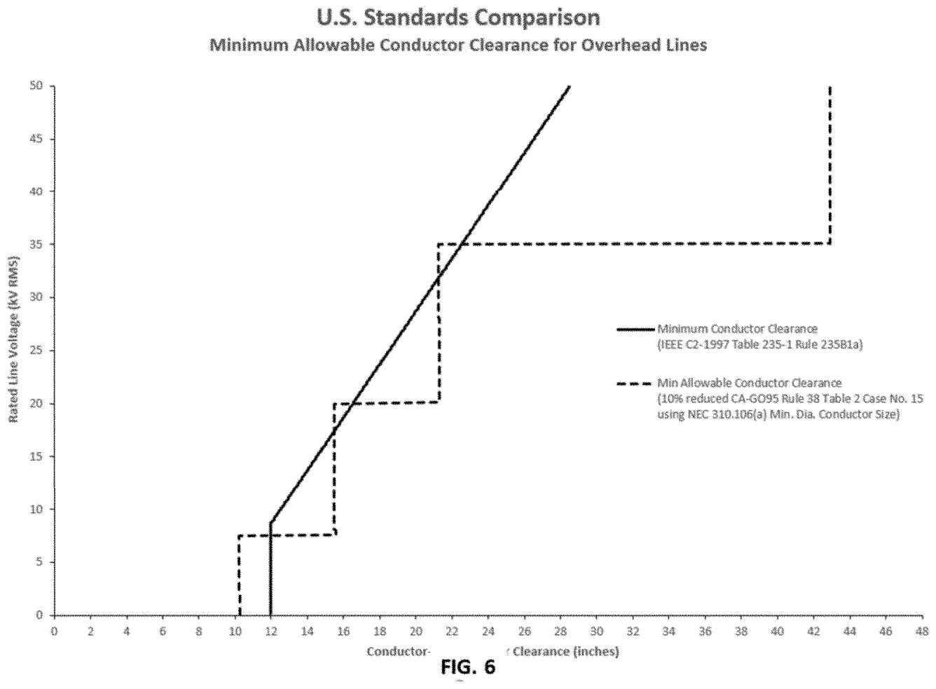

A further improvement to the balloon's overall breakdown strength can be made by polymer encapsulation of the discontinuous or insular array of metal by either overcoating the metal layer with a polymer coating or incorporating the metal layer within the polymer film layers within the balloon membrane, as suggested by Sarnstrom. FIG. 5 illustrates an example of a balloon membrane film structure 500 having an insular array of metal 501 on the polymer base core 502 with a heat sealable layer 503 therebelow and encapsulated by a polymer coating 505.

The polymer coating could be but are not limited to: polyacrylates, polybutylene terephthalate (PBT), polyethylene (PE), polyethylene terephthalate (PET), polyimides, polyurethane (PU), polyvinyl acetate (PVA), polyvinyl alcohol (PVOH), polyvinylidene fluoride (PVDF), and the like. By eliminating the direct metal to gas electrical interactions, the additional dilectric barrier of the encapsulation polymer between the unmetallized gaps of the metal layer can significantly enhance the surface breakdown strength of the balloon film membrane 500. Typical solvent based flexographic inks used for ornamental decorative printing may not provide sufficient dielectric strength to appreciably increase the surface breakdown strength of the balloon. Improvements of polymer encapsulation may only be realized when the disruptive discharge is a flashover at the balloon surface and not an arc-over through the retained gas within the balloon.

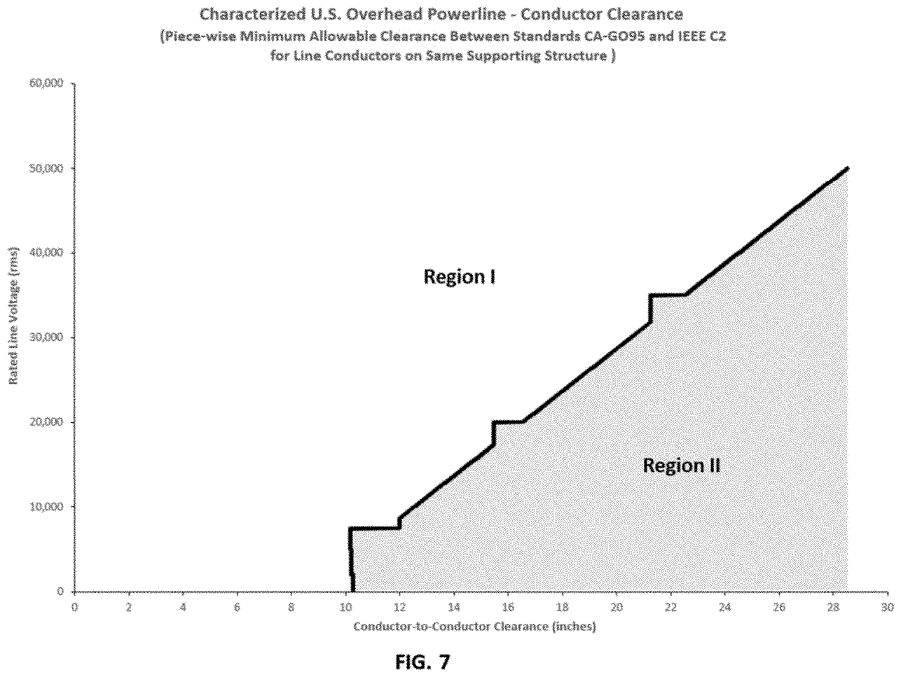

High voltage overhead powerlines tend follow design standards to make the electrical infrastructure inherently safe. A properly designed overhead powerline protects its voltage carrying conductors mainly by physical space separation within an air dielectric. Within the United States, state, local communities, electrical commissions, and electrical municipalities/companies all influence the design of overhead powerlines. However, nearly all governing bodies use design criteria from two established electrical standards: IEEE C2 National Electrical Safety Code or California General Order 95 (CA-GO 95). These standards give guidance on the line-to-line spacing, i.e., conductor-to-conductor clearance, based on the desired powerline voltage level the utilities would like to support. However, the minimum conductor-to-conductor clearance is different between the two standards: In general, the IEEE C2 standard has a continuous voltage-spacing functional relationship while the CA-GO 95 standard has a discrete or step voltage-spacing functional relationship as shown in FIG. 6. For the purpose of this invention, the overhead powerline will be represented by the smallest conductor-to-conductor clearance for a given rated line voltage between the two governing standards More explicitly, the overhead powerline will be characterized and defined as the piece-wise minimum conductor clearance between IEEE C2-1997 Table 235-1 Rule 235B1a, or the 10% reduced California General Order-95 Rule 38 Table 2 Case No. 15 conductor spacing adjusted to conductor clearance by using the NFPA 70 National Electric Code (NEC) Table 310.106(a) minimum conductor size for the rated nominal voltage shown in FIG. 7. The test voltage will also be corrected to the proper rated nominal voltage as defined by ANSI C84.1-2011, table 1, Electric Power Systems Voltage Ratings (60 Hz), Table 1, Voltage Range B for allowable overage voltage.

If we consider all the potential voltage/conductor separation combinations shown in FIG. 7 that could exist, the characterized overhead powerline divides this space into two regions: Region I and Region II. The region in which a balloon electrically breaks down, i.e., creates a disruptive discharge of a flashover or an arc-over, will define whether the balloon is conductive or non-conductive. According to the Standards, current constructed powerlines can exist for any voltage/conductor separation spacing combination in Region II. Hence, there should not be any existing powerline with the voltage/conductor spacing in Region I. Region I represent higher-stress combinations of voltages and conductor clearances not allowed within the U.S. for overhead powerline design, and Region II represents potentially compliant U.S. overhead powerline designs in accordance with the two established standards. The two regions also define whether the balloon is truly conductive or non-conductive. If the balloon has a disruptive discharge under conditions in Region I, the balloon will not affect any existing compliant powerlines and will be considered a safe, non-conductive balloon. If the balloon has a disruptive discharge in Region II or on the characterized overhead powerline, the balloon has the potential to cause a powerline default and will be considered a conductive balloon. Therefore, for a balloon to be considered safe or “non-conductive” within the powerline, the balloon must reliably not arc-over or flash-over at the designed overhead line spacing in the presence of its designed line voltage. Prior art is ambiguous in defining what constitutes a true non-conductive balloon regarding an overhead powerline. Horii does not define a non-conductive balloon but equates an electroconductive property to a threshold of the film's surface dielectric strength, i.e., a film property. Mount specifically states non-conductive is for the film. While this would be valid for a deflated balloon devoid of inflation gas, it may not be valid for a balloon retaining an inflation gas.

It is desirable to conduct electrical testing using the voltages, line spacing, and dynamic loading as in a real world overhead powerline would present. Testing on live electrical lines within the United States is prohibited. There are dedicated testing facilities using realistic line voltages, currents, and conductor configurations that are isolated from the normal electrical grid; but these facilities are limited in number and testing is very costly. The typical high voltage testing facility will simulate the utility power system by using high voltage sources such as generator test sets, high voltage test sets, or high potential power sources capable of achieving the desired rated voltage level but cannot achieve output levels of a real powerline. Guidelines and standards exist, such as IEEE Standard 4 or the IEC 60060 equivalent for high voltage testing techniques using such high voltage sources.

For the purpose of this invention, testing will determine the dielectric breakdown of the balloon and will follow a general procedure of placing a balloon between a pair of test electrodes simulating the electrical conductors of the overhead powerline. The output voltage of a high voltage test set connected to the test electrodes will be increased until a balloon disruptive discharge occurs, such as an arc-over or a flashover. Alternatively, an inflated balloon may be mechanically raised into the pair of energized electrodes until it bridges the electrodes to perform a voltage withstand test. Progressive breakdown or withstand voltage testing is performed on a predefined number of identical samples. It is assumed that the high voltage test setup can deliver sufficient output current to prevent voltage sag even in the presence of partial discharges through the inflation gas. This ensures that the test voltage triggering the disruptive discharge is the same voltage necessary to create a powerline/balloon incident within the normal electrical grid even though the high voltage test setup delivers a much lower short-circuit current.

The tested examples contained with this invention illustrates the concepts of this invention and is not intended to be limiting in either the balloon film membrane composition and structure, the type and design of the metalized layer, and/or the helium-dielectric gas admixture composition.

### Key

PBT=polybutylene terephthalate
PE=polyethylene
PET=polyethylene terephthalate
PU=polyurethane
PVA=polyvinyl acetate
PVOH=polyvinyl alcohol
PVDF=polyvinylidene fluoride

### EXAMPLES

### Example 1

A typical, non-latex, clear polymeric balloon, free of any metal, inflated with 99.999% pure helium.
The balloon membrane is a surfaced printed multilayered polymeric film comprising a nylon layer, a helium barrier layer, and a heat sealable layer.
The film structure consists of Ink/Nylon/EVOH/Nylon/PE.

### Example 2

A typical, non-latex, white pigmented polymeric balloon, free of any metal, inflated with 99.999% pure helium.
The balloon membrane is a surfaced printed multilayered polymeric film comprising a nylon layer and a heat sealable layer containing a concentration of titanium dioxide (Tio2) particles.
The balloon membrane film structure consists of Ink/Nylon/PE with TiO2.

### Example 3

A discontinuous metalized nylon balloon inflated with 99.999% pure helium.
The balloon film membrane is a surface printed multilayered polymeric film comprising a discontinuous metal layer, a nylon layer, a helium barrier layer, and a heat sealable layer.
The metal layer is an insular array of circular vapor-deposited aluminum arranged in a symmetrical-dense packed pattern with 77-78% metal coverage.
The balloon membrane film structure consists of Ink/Metal/Nylon/EVOH/Nylon/PE.

### Example 4

A discontinuous metalized, ceramic coated, PET balloon inflated with 99.999% pure helium.
The balloon membrane film is a surface printed multilayered polymeric film comprising a discontinuous metal layer, a helium barrier layer, a PET layer, and a heat sealable layer.
The metal layer is an insular array of circular vapor-deposited aluminum arranged in a symmetrical-dense packed pattern with 77-78% metal coverage.
The balloon film structure consists of Ink/Metal/Acrylic/AlOx/PET/PE

### Example 5

An encapsulated, discontinuous metalized PET balloon inflated with 99.999% pure helium.
The balloon film membrane is a surface printed multilayered polymeric film comprising an encapsulating layer, a discontinuous a metal layer, a PET layer, and a heat sealable layer.
The metal layer is an insular array of circular vapor-deposited aluminum arranged in a symmetrical-dense packed pattern with 77-78% metal coverage.
The film structure consists of Ink/PVA/Metal/PET/PE.

### Example 6

A discontinuous metalized PET balloon inflated with 99.999% pure helium.
The balloon film membrane is a surface printed multilayered polymeric film comprising a discontinuous metal layer, a PET layer, and a heat sealable layer
The metal layer is an insular array of circular vapor-deposited aluminum arranged in a symmetrical-dense packed pattern with 77-78% metal coverage.
The film structure consists of Ink/Metal/PET/PE

### Example 7

A typical, non-latex, clear polymeric balloon, free of any metal, inflated with an admixture of 95% helium and 5% oxygen.
The balloon film membrane is a surfaced printed multilayered polymeric film comprising a nylon layer, a helium barrier layer, and a heat sealable layer.
The balloon membrane film structure consists of Ink/Nylon/EVOH/Nylon/PE.

### Example 8

A typical, non-latex, white pigmented polymeric balloon, free of any metal, inflated with an admixture of 95% helium and 5% oxygen
The balloon film membrane is a surfaced printed multilayered polymeric film comprising a nylon layer and a heat sealable layer containing a concentration of titanium dioxide particles (TiO2).
The balloon film structure consists of Ink/Nylon/PE with TiO2.

### Example 9

A discontinuous metalized nylon balloon inflated with an admixture of 95% helium and 5% oxygen.
The balloon film membrane is a surface printed polymeric multilayered film comprising a discontinuous metal layer, a nylon layer, a helium barrier layer, and a heat sealable layer.
The metal layer is an insular array of circular vapor-deposited aluminum arranged in a symmetrical-dense packed pattern with 77-78% metal coverage.
The balloon film structure consists of Ink/Metal/Nylon/EVOH/Nylon/PE

### Example 10

A discontinuous metalized, ceramic coated, PET balloon inflated with an admixture of 95% helium and 5% oxygen.
The balloon film membrane is a surface printed multilayered polymeric film comprising a discontinuous metal layer, a helium barrier layer, a PET layer, and a heat sealable layer.
The metal layer is an insular array of circular vapor-deposited aluminum arranged in a symmetrical-dense packed pattern with 77-78% metal coverage.
The balloon film structure consists of Ink/Metal/Acrylic/AlOx/PET/PE

### Example 11

An encapsulated, discontinuous metalized PET balloon inflated with an admixture of 95% helium and 5% oxygen.
The film membrane is a surface printed multilayered film containing an encapsulating layer, a discontinuous metal layer, a PET layer, and a heat sealable layer.
The metal layer is an insular array of circular vapor-deposited aluminum arranged in a symmetrical-dense packed pattern with 77-78% metal coverage.
The film structure consists of Ink/PVA/Metal/PET/PE.

### Example 12

A discontinuous metalized PET balloon inflated with an admixture of 95% helium and 5% oxygen.
The balloon film membrane is a surface printed multilayered polymeric film comprising a discontinuous metal layer, a PET layer, and a heat sealable layer.
The metal layer is an insular array of circular vapor-deposited aluminum arranged in a symmetrical-dense packed pattern with 77-78% metal coverage.
The balloon film structure consists of Ink/Metal/PET/PE.

Progressive breakdown testing using examples 1 through 6 utilized a pair of utility-grade 14.4 kV 1.5 kVA potential transformers as the high voltage power source. The low voltage (120 volt) inputs of the potential transformers are connected anti-parallel, inductively and resistively ballasted to limit short-circuit current, and driven from a 0-140-volt 20 A variac. The high voltage outputs of the potential transformers are connected in series to form a center-tapped high-voltage transformer with a nominal leg-leg output voltage of 28 kV. The high voltage “center tap” of the pair of potential transformers was also earth grounded. A high-voltage resistor-capacitor network was also connected across the potential transformer outputs. This allowed the charged capacitor in the resistor-capacitor circuit to rapidly discharge hundreds of milliamperes through any newly formed spark channel, creating a distinctive, and very visible, flash that signaled the event. The capacitance also provided a bit of resonant rise (with the ballast inductance), increasing the maximum output voltage to 34-38 kV depending on ballast setting. The potential transformer outputs were also connected to a pair of parallel one inch diameter copper pipes, acting as electrodes and simulating the line conductors of the overhead powerline, and could be adjusted for various spacings in one-inch increments. For balloon voltage breakdown testing, this test setup should behave as a pair of spaced phase-to-phase lines except it will not deliver the huge 60 Hz fault currents seen in an overhead power system.

Tests using Examples 7 through 12 required a higher voltage source than the tests conducted using examples 1 through 6. The high voltage source was switched to an 80 kV (peak) X-ray transformer repacked into a metal container and fully immersed and vacuum impregnated with transformer oil. The primary of the X-ray transformer was driven from a pair of cascaded 120-volt variable transformers in series with a 6-ohm power resistor bank. This configuration limited the high voltage short-circuit current to about 15 mA. The amperage required for streamer formation in the helium-oxygen admixture was significantly lower than the amperage needed for streamer formation in the 100% helium gas, thus the resistor-capacitor circuit was not needed in this equipment setup. Maximum reliable output voltage for this transformer configuration was limited to 56 kV RMS.

In all examples, the balloon was inflated with the inflation gas by a Conwin Precision Plus foil-balloon regulator delivering 16-18 inches of water column gauge pressure and inflated to a physical size of approximately 20.5 inches in diameter by 12.75 inches deep. The balloon was slightly wedged between the pair of 1 inch diameter copper pipes. The output voltage of the high voltage transformer was slowly ramped up until there was a visual indication of either an arc-over, or a flash-over, or reached the transformer's maximum output voltage without a disruptive discharge. The output voltage was measured by a true RMS multimeter across a compensated 1,000:1 60 kV voltage divider with the voltage divider connected to one leg of the high voltage transformer.

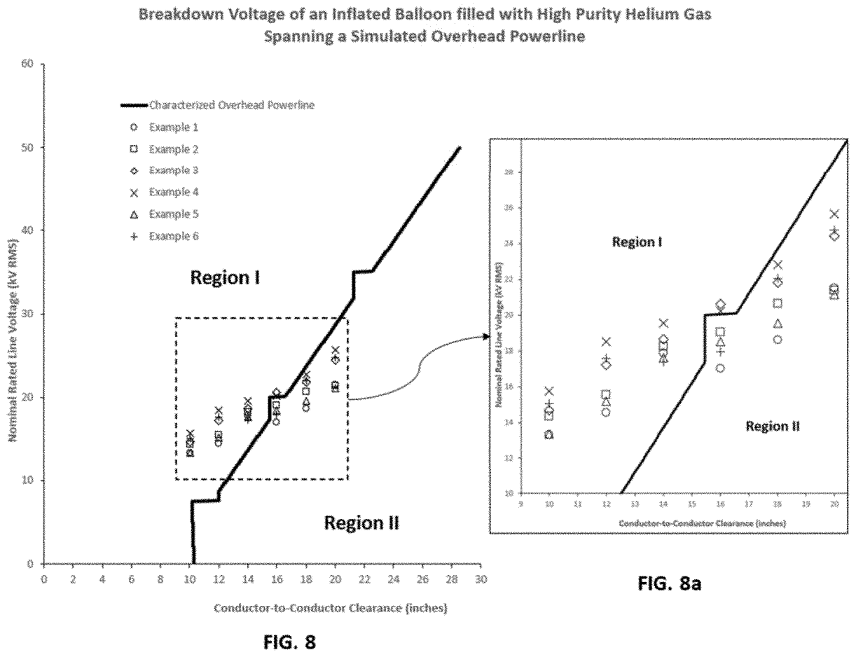

The testing of Examples 1 through 6 (shown in FIGS. 8 and 8a) demonstrate when the balloon membrane is classified as “non-conductive”, the balloon can become conductive to overhead powerlines when inflated with relatively pure helium. Test results also show the metal-free balloons of Examples 1 and 2, as well as the discontinuous metalized balloons of Examples 3 through 6, all behaved very similar to each other having arc-overs through the helium inflation gas roughly the same line voltage and conductor clearance values (17 to 21 kV RMS0 at 15.5 to 16.5 inches clearance). Hence a discontinuous metalized polymeric balloon can be configured to mimic the electrical characteristics of a metal-free polymeric balloon when inflated with pure helium.

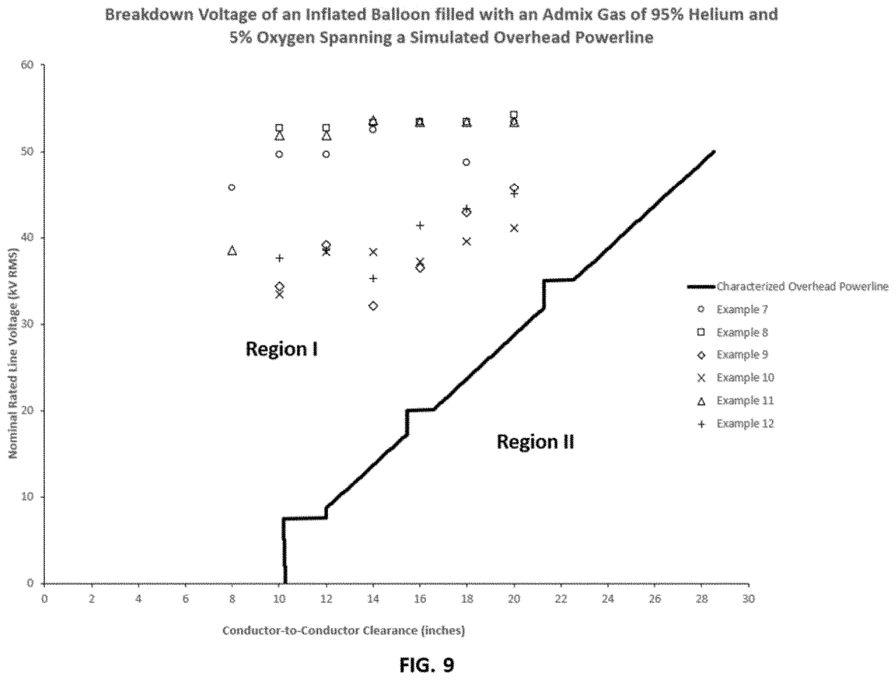

When the same balloon membranes used in Examples 1 through 6 are inflated with the admixture gas of 95% helium and 5% oxygen (shown in FIG. 9 as Examples 7 through 12), the balloon voltage breakdown strength significantly increased but in various degrees of improvement. Discontinuous metalized balloons of Examples 9, 10 and 12 demonstrate voltage breakdowns of flashovers across the surface of the balloon indicating the configuration of the metal deposit geometry potential limiting the breakdown improvement. Examples 7 and 8 reached the output voltage limit of the test equipment without a breakdown, this indicating the composition of the inflation gas can significantly contribute to the electrical characteristics of the balloon, particularly when helium is used as the lighter-than-air gas. The encapsulated discontinuous metalized balloon of Example 11 also reached the voltage limit of the test equipment and clearly shows a significant enhancement in breakdown voltage over the patterned metalized balloons of Examples 9, 10 and 12, thus demonstrating the benefits of encapsulating the metal deposits in polymer.

The balloons in Examples 7 through 12 all remained non-conductive to the distribution class overhead powerlines.

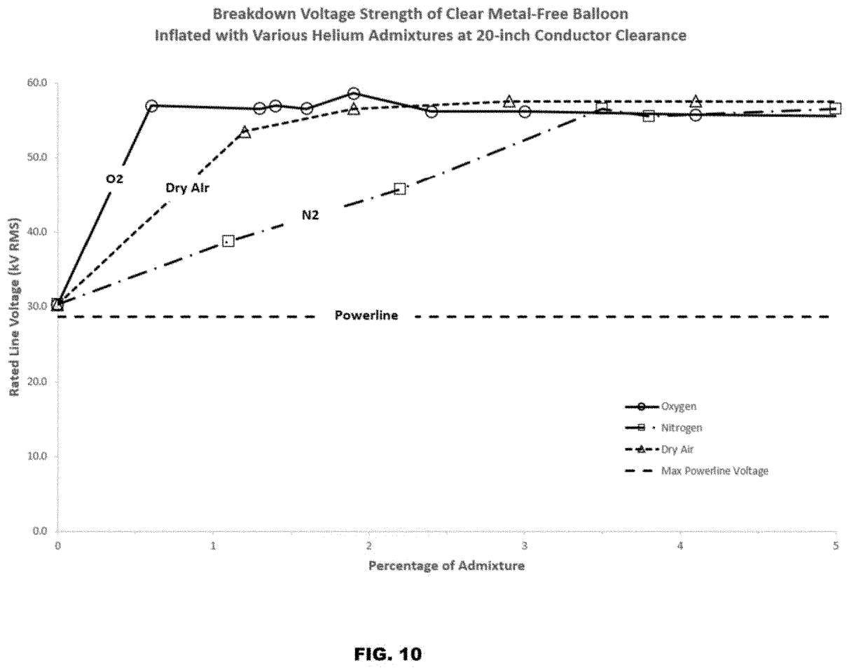

Additional test were performed to characterize breakdown voltages of various admixtures of helium with oxygen, synthetic air, and dry nitrogen at target concentrations in the range of 0 to 5%. For these tests, a clear balloon with surfaced printed multilayered polymeric balloon membrane comprising a nylon layer and a heat sealable layer was used with electrode clearance of 10, 16 and 20 inches. Results of a 20 inch gap with various admixtures at various concentrations are shown in FIG. 10. Maximum voltage output of the test equipment was limited to approximately 56 k by test equipment limitations. Test results greater than 55 kV are withstand voltages and not actual breakdown voltages. The rated line voltage of a 20 inch conductor clearance is 29.1 kV in accordance with the IEEE C2 specifications, i.e., the characterized overhead powerline. Spark breakdowns were prevented when balloons were inflated with admixtures containing at least 1% oxygen or at least 2% air. This is attributable to the strong electron capturing effect of even small concentrations of oxygen. Removing free electrons increases onset voltages for corona, streamer and leader growth. Admixture using only dry nitrogen are as effective as those containing oxygen (or oxygen as a component of air) since nitrogen is not an electronegative gas.

Although most U.S. overhead power distribution systems use maximum phase-to-phase voltages of 33 to 35 kV, a few utilities use 38 kV. The corresponding minimum Characterized Overhead Powerline clearance at 38 kV is 23.7 inches. This represents the highest voltage stress (1691 volts/inches) that a 24 inch balloon might encounter within any U.S. power distribution system. Testing has confirmed that nonconductive balloons, when inflated with a helium admixture containing 5% oxygen, should safely withstand phase-to-phase contact with a 38 kV distribution line without suffering catastrophic breakdown. Admixtures containing lower oxygen content or He-air admixtures may be sufficient for regions that use lower distribution system voltages. An emerging IEEE testing standard for non-conducting balloon will likely specify a 5% oxygen 95% helium admixture during qualification testing.

The above specification, examples and FIGS. are for illustrative purposed only. The true scope of this inventions is described in the following claims.

What is claimed:

1. A discontinuous metalized celebratory lighter-than-air nylon film balloon, comprising:
a) the nylon film balloon is to be inflated with 99.999% pure helium; and
b) the nylon film is a surface printed and contains a discontinuous metal layer, a nylon layer, a helium barrier layer, and a heat sealable layer.

2. The celebratory lighter-than-air nylon film balloon of claim 1, wherein the metal layer is a discontinuous aluminum vapor-deposition with a shape pattern of 0.815 mm diameter metal circles densely stacked on a 60-degree hexagonal lattice with a 7.4% separation-to-spacing ratio.

3. The celebratory lighter-than-air nylon film balloon of claim 1, having an inside and an outside wherein the nylon film further comprises from the outside to the inside of the balloon ink/Metal/Nylon/EVOH/Nylon/PE.

4. A discontinuous metalized, ceramic coated, celebratory lighter-than-air PET film balloon, comprising:
a) the PET balloon is be inflated with 99.999% pure helium; and
b) the PET film is surface printed and contains a discontinuous metal layer, a helium barrier layer, a PET layer, and a heat sealable layer.

5. The discontinuous metalized, ceramic coated, celebratory lighter-than-air PET film balloon claim of claim 4, wherein the metal layer is an insular array of circular vapor-deposited aluminum arranged in a symmetrical-dense packed pattern with 77-78% metal coverage.

6. The discontinuous metalized, ceramic coated, celebratory lighter-than-air PET film balloon of claim 4, having an inside and an outside wherein the PET film further comprises from the outside to the inside the balloon to Ink/Metal/Acrylic/AlOx/PET/PE.

7. An encapsulated, discontinuous metalized PET filmlighter-than-air celebratory balloon, comprising:
a) the PET balloon is to be inflated with 99.999% pure Helium; and
b) the PET film is surface printed and contains a discontinuous metal layer within an encapsulating layer, a PET layer, and a heat sealable layer.

8. The discontinuous metalized, ceramic coated, celebratory lighter-than-air PET film balloon claim of claim 7, wherein the metal layer is an insular array of circular vapor-deposited aluminum arranged in a symmetrical-dense packed pattern with 77-78% metal coverage.

9. The discontinuous metalized, celebratory lighter-than-air PET film balloon claim of claim 7, having an inside and an outside wherein the PET film further comprises from the outside to the inside Ink/PVA/Metal/PET/PE.

10. A discontinuous metalized, ceramic coated, celebratory lighter-than-air PET film balloon, comprising:
a) the PET balloon is intended to be inflated with 99.999% pure helium;
b) the PET film is surface printed and contains a discontinuous metal layer, a helium barrier layer, a PET layer, and a heat sealable layer; and
c) the balloon having an inside and an outside wherein the PET film further comprises from the outside to the inside the balloon to Ink/Metal/PET/PE.

11. The discontinuous metalized, ceramic coated, celebratory lighter-than-air PET film balloon of claim 10, wherein the metal layer is an insular array of circular vapor-deposited aluminum arranged in a symmetrical-dense packed pattern with 77-78% metal coverage.

12. A celebratory lighter-than-air, non-latex, clear, free from any metal, balloon fabricated from polymetric films, comprising:
a) the polymetric films form a balloon membrane that is surface printed and has a nylon layer, a helium barrier layer and a heat sealable layer; and
b) the membrane is to be filled with a lighter-than-air inflation admixture of helium and at least one dielectric gas.

13. The celebratory lighter-than-air balloon of claim 12, having an inside and an outside wherein the nylon film further comprises from outside to inside of the balloon Ink/Nylon/EVOH/Nylon/PE.

14. The celebratory lighter-than-air, balloon of claim 12 wherein the dielectric gas is oxygen.

15. The celebratory lighter-than-air balloon of claim 12, wherein the admixture is 95% helium and 5% oxygen.

16. The celebratory lighter-than-air balloon of claim 12, wherein the balloon having an inside and an outside and is printed with ink thereon and the polymetric films from outside to inside comprise nylon, EVO, a second nylon and polyethylene.

17. A celebratory, non-latex, white pigmented film balloon, free of any metal, comprising:
a) the film forms a balloon membrane that is surface printed containing a nylon layer and a heat sealable layer containing a concentration of titanium dioxide particles; and
b) the membrane is to be filled with a lighter-than-air inflation admixture of helium and at least one dielectric gas.

18. The celebratory lighter-than-air, balloon of claim 17 wherein the dielectric gas is oxygen.

19. The celebratory lighter-than-air balloon of claim 17, wherein the admixture is 95% helium and 5% oxygen

20. A discontinuous metalized celebratory lighter-than-air nylon film balloon, comprising:
a) the nylon film balloon is inflated with admixture of 95% helium and at least one dielectric gas; and
b) the nylon film is a surface printed and contains a discontinuous metal layer, a nylon layer, a helium barrier layer, and a heat sealable layer.

21. The celebratory lighter-than-air nylon film balloon of claim 20, wherein the metal layer is an insular array of circular vapor-deposited aluminum arranged in a symmetrical-dense packed pattern with 77-78% metal coverage.

22. The celebratory lighter-than-air nylon film balloon of claim 20, having an inside and an outside wherein the nylon film further comprises from outside to inside of the balloon Ink/Metal/Nylon/EVOH/a second nylon/PE.

23. The celebratory lighter-than-air, balloon of claim 20 wherein the dielectric gas is oxygen.

24. The celebratory lighter-than-air balloon of claim 20 wherein the admixture is 95% helium and 5% oxygen.

25. A celebratory, discontinuous metalized, lighter than air PET film balloon, comprising:
a) the PET balloon is intended to be inflated with admixture of 95% Helium and 5% dielectric gas; and
b) the PET film is surface printed and contains a discontinuous metal layer, a PET layer, and a heat sealable layer.

26. The discontinuous metalized, ceramic coated, celebratory lighter-than-air PET film balloon claim of claim 25, wherein the metal layer is an insular array of circular vapor-deposited aluminum arranged in a symmetrical-dense packed pattern with 77-78% metal coverage.

27. The discontinuous metalized, celebratory lighter-than-air PET film balloon claim of claim 25, having an inside and an outside wherein the PET film further comprises the outside to the inside Ink/metal/acrylic/ALox/PET/PE.

28. The celebratory lighter-than-air, balloon of claim 25 wherein the dielectric gas is oxygen.

29. A celebratory, encapsulated, discontinuous metalized PET film balloon, comprising:
a) the PET balloon is inflated with an admixture of 95% pure Helium and 5% of at least one dielectric gas; and
b) the PET film is surface printed and contains a discontinuous metal layer within an encapsulating layer, a PET layer, and a heat sealable layer.

30. The discontinuous metalized, ceramic coated, celebratory lighter-than-air PET film balloon claim of claim 29, wherein the metal layer is an insular array of circular vapor-deposited aluminum arranged in a symmetrical-dense packed pattern with 77-78% metal coverage.

31. The discontinuous metalized, celebratory lighter-than-air PET film balloon claim of claim 29, having an inside and an outside wherein the PET film further comprises from the outside to the inside Ink/PVA/Metal/PET/PE.

32. A celebratory discontinuous metalized PET film balloon, comprising:
a) the PET balloon is inflated with an admixture of 95% pure Helium and 5% of at least one dielectric gas; and
b) the PET film is surface printed and contains a discontinuous metal layer, a PET layer, and a heat sealable layer.

33. The discontinuous metalized, ceramic coated, celebratory lighter-than-air PET film balloon claim of claim 32, wherein the metal layer is an insular array of circular vapor-deposited aluminum arranged in a symmetrical-dense packed pattern with 77-78% metal coverage.

34. The discontinuous metalized, celebratory lighter-than-air PET film balloon claim of claim 32, having an inside and an outside wherein the PET film further comprises from the outside to the inside Ink/metal/PET/PE.

35. The discontinuous metalized, celebratory lighter-than-air PET film balloon claim of claim 32 wherein the dielectric gas in oxygen.
